(19) United States
(12) Patent Application Publication
(10) Pub. No.: US 2018/0322447 A1
(43) Pub. Date: Nov. 8, 2018

(54) APPARATUS AND METHOD FOR NON-WEIGHT-BASED CONSUMPTION MONITORING AND AUTOMATIC REPLACEMENT INITIATION

(71) Applicant: Walmart Apollo, LLC, Bentonville, AR (US)

(72) Inventor: Robert L. Cantrell, Herndon, VA (US)

(21) Appl. No.: 15/969,622

(22) Filed: May 2, 2018

Related U.S. Application Data
(60) Provisional application No. 62/500,010, filed on May 2, 2017.

(51) Int. Cl. G06Q 10/08

(52) U.S. Cl. CPC G06Q 10/087

(57) ABSTRACT

An apparatus and method support storage and automatic replacement of a consumable item in an end-user consumer's application setting. These teachings provide for using at least one non-weight-based sensor (such as an image-based sensor and/or an ultrasonic-based sensor) configured to be physically deployed within a storage area and to sense a non-fully-depleted consumption state of the consumable item within the end user consumer's application setting. These teachings also provide for using a control circuit that operably couples to the non-weight-based sensor and that is configured to respond to detection of a particular non-fully-depleted consumption state (for example, a consumption state between 70 percent depleted and 90 percent depleted) by automatically initiating replacement of the consumable item within the storage area.

### CROSS-REFERENCE TO RELATED APPLICATION

This application claims the benefit of U.S. Provisional Application No. 62/500,010, filed May 2, 2017, and is incorporated herein by reference in its entirety.

### TECHNICAL FIELD

These teachings relate generally to the replacement of consumable items including the monitoring of corresponding consumption and more particularly to the use of non-weight-based consumption sensing.

### BACKGROUND

While many material accoutrements of modern life are relatively durable and long-lived, in fact, many consumable products are, by their very nature, consumable and, upon being consumed, require replacement. Examples include but are not limited to edible products and any of a wide variety of cleaning products.

Some products that are designed to utilize consumable ingredients or components (such as coffee brewers) have a built-in capability to detect when the consumable ingredient/component is fully consumed and to then initiate some replacement protocol. While potentially useful, such an approach inherently leaves the vast majority of consumable items in a typical end user consumer's application setting unaccounted for. The latter result occurs at least in part because many consumable items are stored in storage areas that are separate and apart from the apparatus that consumes a corresponding consumable item and hence beyond the sensing range of the apparatus.

Accordingly, as a general principle, the end user consumer remains personally responsible for monitoring the use and consumption of their various consumable items to ensure that corresponding replacements are available in a timely fashion. Such a strategy, of course, remains subject to human frailty. As a result, many end-user consumers are all too familiar with the disappointment, frustration, and inconvenience that accompanies discovering a present lack of availability of a particular consumable item.

### BRIEF DESCRIPTION OF THE DRAWINGS

The above needs are at least partially met through provision of the apparatus and method for non-weight-based consumption monitoring and automatic replacement initiation described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a time lapse view as configured in accordance with various embodiments of these teachings;

FIG. 4 comprises a top plan view as configured in accordance with various embodiments of these teachings; and

FIG. 5 comprises a top plan view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments pertain to an apparatus and method to support storage and automatic replacement of a consumable item in an end-user consumer's application setting. These teachings provide for using at least one non-weight-based sensor (such as an image-based sensor and/or an ultrasonic-based sensor) configured to be physically deployed within a storage area and to sense a non-fully-depleted consumption state of the consumable item within the end user consumer's application setting. These teachings also provide for using a control circuit that operably couples to the non-weight-based sensor and that is configured to respond to detection of a particular non-fully-depleted consumption state (for example, a consumption state between 70 percent depleted and 90 percent depleted) by automatically initiating replacement of the consumable item within the storage area.

As used herein, the aforementioned storage area is not a storage area that comprises an integral part of an apparatus that is itself configured to consume the consumable item. Examples of useful storage areas include residential refrigerators, residential freezers, residential pantries, residential closets, residential cupboards, residential cabinets, and residential shelves.

These teachings are highly flexible in practice and will accommodate a variety of approaches to automatically initiating the replacement of a particular consumable item within the storage area. By one approach, the aforementioned control circuit automatically orders the consumable item to thereby replenish the available supply. By another approach, the control circuit automatically orders an item that is an alternative to the consumable item. By yet another approach, the control circuit automatically notifies the end-user consumer regarding the opportunity to replace the consumable item. By yet another approach the control circuit provides the end-use the consumer with an opportunity to permit or not permit replacement of the consumable item. And by yet another approach, the control circuit automatically notifies the end-user consumer regarding an opportunity to replace the consumable item by presenting the end-user consumer with at least one item that is an alternative to the consumable item.

By one approach the control circuit accesses a set of rules that define re-ordering activities as a function of the non-fully-depleted consumption state of the consumable item and uses those rules to automatically initiate placement of the consumable item within the storage area.

So configured, any of a wide variety of consumable items can be monitored as regards their consumption state and appropriate actions taking to facilitate replenishment of the monitored items. These teachings will accommodate monitoring both items that require refrigeration as well as those items that will tolerate or require dry storage.

When employing a rules-based approach, these teachings will accommodate using different replenishment strategies for different products to suit, for example, user preferences and/or storage, replenishment, and/or rate-of-use parameters for individual items. Accordingly, replenishment initiation can begin earlier for an item experiencing a relatively high rate of use as compared to an item experiencing a relatively low rate of use. As another example, replenishment initiation can begin relatively earlier for an item having a typically longer order fulfillment cycle as compared to an item that is typically available on relatively short notice.

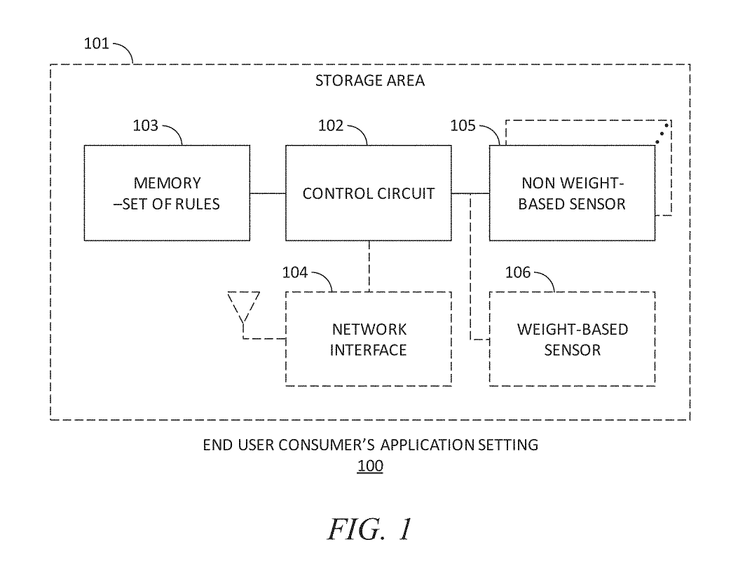

These and other benefits may become clearer upon making a thorough review and study of the following detailed description. Referring now to the drawings, and in particular to FIG. 1, an illustrative apparatus that is compatible with many of these teachings will now be presented.

These teachings presume an end user consumer's application setting 100. Such an application setting will typically comprise a residential dwelling such as a home, apartment, dormitory, or the like. These teachings will also accommodate, however, an application setting such as an academic or office setting where the end user consumer, although not in a residential context per se, nevertheless personally consumes one or more consumable items for their own benefit.

This end-user consumer's application setting 100 includes at least one storage area 101. Examples of a storage area 101 include a residential refrigerator, a residential freezer, a residential pantry, a residential closet, a residential cupboard, a residential cabinet, and a residential shelf. It may be noted that these storage areas are relatively general in nature and are not an integral part of an apparatus that itself serves to consume an item stored within the storage area 101. Instead, such storage areas are agnostic in that any of a wide variety of consumable items can be stored therein, which items can be quite unrelated to one another in terms of ingredients, components, and/or usage.

In this particular example, the enabling apparatus includes a control circuit 102. Being a “circuit,” the control circuit 102 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 102 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 102 is configured (for example, by using corresponding programming as will be well understood by those skilled in the art) to carry out one or more of the steps, actions, and/or functions described herein.

In this example the control circuit 102 operably couples to a memory 103. This memory 103 may be integral to the control circuit 102 or can be physically discrete (in whole or in part) from the control circuit 102 as desired. This memory 103 can also be local with respect to the control circuit 102 (where, for example, both share a common circuit board, chassis, power supply, and/or housing) or can be partially or wholly remote with respect to the control circuit 102 (where, for example, the memory 103 is physically located in another facility, metropolitan area, or even country as compared to the control circuit 102).

This memory 103 can serve, for example, to non-transitorily store the computer instructions that, when executed by the control circuit 102, cause the control circuit 102 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) By one approach these instructions include a set of rules as described further herein.

By one optional approach the control circuit 102 also operably couples to a network interface 104. So configured the control circuit 102 can communicate with other elements (for example, within the apparatus, the storage area 101, the end user consumer's application setting 100, or other remotely-located elements such as third party servers) via the network interface 104. Network interfaces, including both wireless and non-wireless platforms, are well understood in the art and require no particular elaboration here.

The control circuit 102 operably couples to at least one non-weight-based sensor 105. By one approach the non-weight-based sensor 105 comprises an image-based sensor (such as but not limited to a still or video camera). By another approach, in lieu of the foregoing or in combination therewith, the non-weight-based sensor 105 comprises an ultrasonic-based sensor. Such sensors 105 can provide sensor information that alone or in combination with further processing by the control circuit 102 (for example, to compare and contrast a current image with a previous or historical image) can serve to indicate not only the presence or absence of a particular consumable item but a particular consumption state of that consumable item. For example, the sensor information can indicate that a container of sugar is full, 50 percent consumed, 70 percent consumed, and so forth depending upon the fullness of the container.

By one approach these storage area 101 has one such non-weight-based sensor 105 to monitor the state of consumption for a plurality of different consumable items that are stored within the storage area 101. By another approach, the storage area 101 may have one non-weight-based sensor 105 to monitor the state of consumption for a first grouping of different consumable items in a first part of the storage area 101 and another non-weight-based sensor 105 to monitor the state of consumption for a second grouping of different consumable items in a second part of the storage area 101 (where the second part of the storage area 101 may or may not partially overlap with the second part of the storage area 101). It would of course also be possible for the storage area 101 to have a discreet non-weight-based sensor 105 for each storable consumable item to individually monitor a single corresponding consumable item.

By one approach the consumable items are stored in the storage area 101 in their original packaging and/or using containers of choice as desired. If desired, however, these teachings can be applied in conjunction with reusable containers that are configured to hold and retain one or more consumable items to facilitate the aforementioned sensing of the consumption state of such items. Accordingly, such a container may have, for example, transparent or highly translucent walls to facilitate observing the consumable items contained therein. As another example, the container may have pockets, slots, shelves, walls, and other physical features to segregate and/or otherwise physically organize the items to make it easier to assess their relative states of consumption. These teachings will also accommodate installing one of more of the non-weight-based sensors 105 into such a container as an integral part thereof if desired.

By one approach the control circuit 102 communicatively couples to a non-weight-based sensor 105 via a non-wireless connection. By another approach, the control circuit 102 communicatively couples to a non-weight-based sensor 105 via a wireless connection (such as, for example, a direct Bluetooth connection or an indirect (i.e., via an access point) Wi-Fi connection).

If desired, these teachings will accommodate also using one or more weight-based sensors 106 to monitor the consumption state of one or more consumable items in the storage area 101. Such weight-based sensors 106, when employed, can be used in conjunction with the aforementioned non-weight-based sensors 105 or can be utilized for specific consumable items that might be otherwise difficult to monitor.

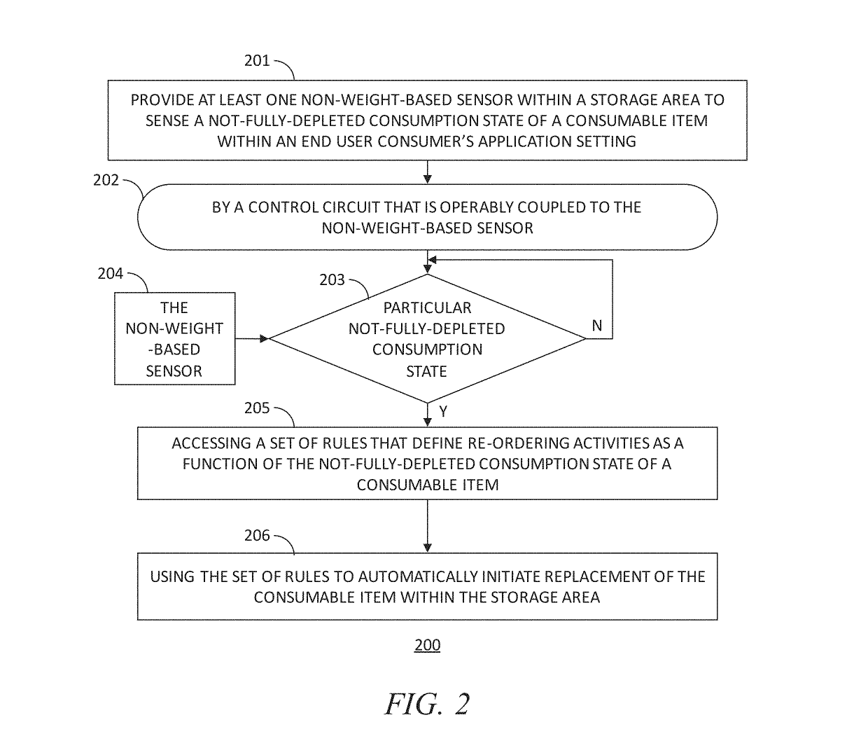

FIG. 2 presents a process 200 that can be employed using the apparatus described above in FIG. 1. For example, block 201 of this process 200 provides at least one non-weight-based sensor within a storage area to sense a non-fully-depleted consumption state of a consumable item within an end user consumer's application setting as described in FIG. 1. Then, as denoted by reference numeral 202, the remaining steps of this process 200 can be carried out by the aforementioned control circuit 102 that operably couples to the utilized non-weight-based sensors 105.

At decision block 203, the control circuit 102 utilizes input from one or more of the non-weight-based sensors 105 (see block 204) to detect a particular non-fully-depleted consumption state of a particular monitored consumable item. By way of an illustrative example, this can comprise detecting that a particular monitored consumable item is now at least 50 percent depleted. As another illustrative example, this can comprise detecting that a particular monitored consumable item is now at least 70 percent depleted. And as yet another illustrative example, this can comprise detecting that a particular monitored consumable item is now at least 90 percent depleted.

These teachings will accommodate using a same particular not-fully-depleted consumption state for all monitored consumable items. By another approach, however, different trigger consumption states can be utilized for different corresponding consumable items. By one approach the end user consumer makes particular selections in these regards (perhaps by deviating from a default value such as 90 percent depleted). By another approach the control circuit 102 may make dynamic, automatic selections in these regards. As regards the latter approach, the control circuit 102 may have an ability to detect categorical specifics regarding a particular monitored consumable item (for example, via an optical code reader that reads a Universal Product Code barcode on the packaging of a particular consumable item and/or via a radio-frequency identification (RFID) reader that reads an RFID tag that corresponds to the particular consumable item). In this case, the aforementioned set of rules can specify the use of particular pre-determined trigger consumption states as a function of particular consumable items and/or particular consumable item categories.

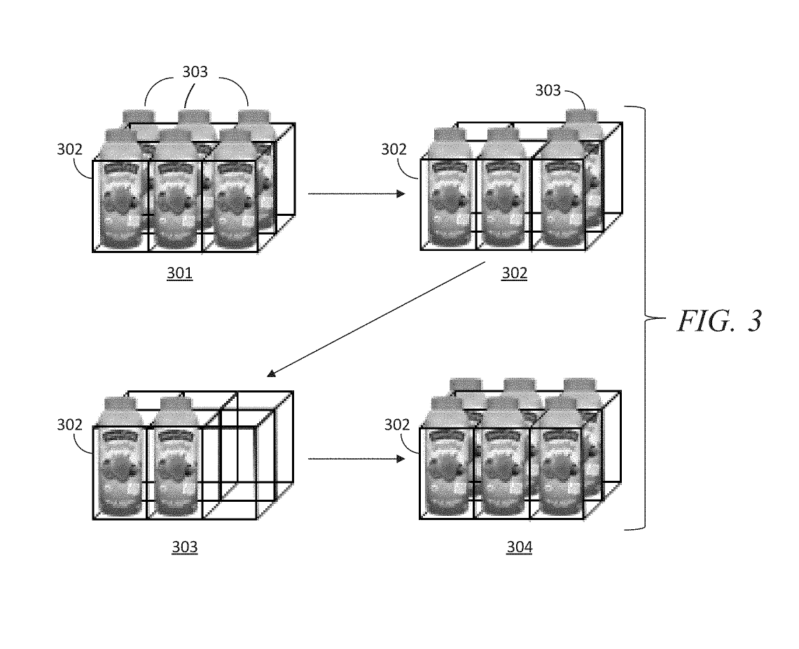

FIG. 3 provides an illustrative example in these regards. In this example, at an initial state of consumption as denoted by reference numeral 301, a partitioned container 302 contains six individual servings of a liquid beverage 303. In this example the initially-full partitioned container 302 contains six such individual servings. At some later time, and as denoted by reference numeral 302, two of the individual servings have been removed, leaving four individual servings. In this particular example, this particular non-fully-depleted consumption state does not represent a trigger consumption state.

At some still later time, and as denoted by reference numeral 303, four of the individual servings have been removed, leaving only two individual servings in the partitioned container 302. In this particular example, this particular non-fully-depleted consumption state does represent the trigger consumption state and, as will be shown below, these teachings can respond by automatically initiating replacement of the consumable items in this particular container 302 as shown by reference numeral 304.

Upon detecting the requisite non-fully-depleted consumption state, at block 205 the control circuit 102 accesses the aforementioned set of rules that define re-ordering activities as a function of the not-fully-depleted consumption state of the consumable item. At block 206 the control circuit 102 then utilizes the set of rules to automatically initiate replacement of the consumable item within the storage 101.

By one approach, the set of rules specifies a same re-ordering activity regardless of the consumable item (or category of consumable item) that requires reordering. By another approach, the set of rules can specify different re-ordering activities depending on the consumable item (or category of consumable item) that requires reordering.

In any event, these teachings will accommodate a wide variety of re-ordering activities. By one approach, for example, the set of rules provide for automatically initiating the replacement of the consumable item within the storage area 101 by automatically ordering at least one new one of the consumable item. This ordering may be undertaken via a communication via the aforementioned network interface 104. For example, the control circuit 102 may communicate with a retail supplier of this particular consumable item to order the requisite resupply. The aforementioned rules can specify any of a variety of conditions including a deliver-by date, a delivery window, a request or requirement that the ordered item be delivered in combination with one or more other previously or currently ordered items, a particular method of payment, presentation of a promotional discount or the like, and so forth as desired.

By one approach the control circuit 102 undertakes this activity without providing any concurrent or corresponding notice to the end-user consumer. By another approach the control circuit 102 undertakes this activity in combination with providing a concurrent or corresponding notice to the end-user consumer (for example, an email, text message, or in-app alert provided via the aforementioned network interface 104).

By another approach, the set of rules provide for automatically initiating the replacement of the consumable item within the storage area 101 by automatically ordering an item that is an alternative to the consumable item. As used herein it will be understood that, although an alternative, the alternative item will be generally fungible and similar in usage to the consumable item to be replaced. For example, if a particular brand of milk needs replacement, the rules may provide for replacing that milk with a different brand of milk.

The set of rules may provide for using an alternative when and if the exact item is not presently available for replenishment purposes. By another approach, in lieu of the foregoing or in combination therewith, the set of rules may provide for using an alternative as a means of introducing diversity and variety for the consumer and hence may permit or require ordering an alternative even when the exact item is available for ordering. As an illustrative example in these regards, the control circuit 102 may be governed by the set of rules to order a particular brand of consumable item 2 out of every three orders but to order an alternative brand once every three orders.

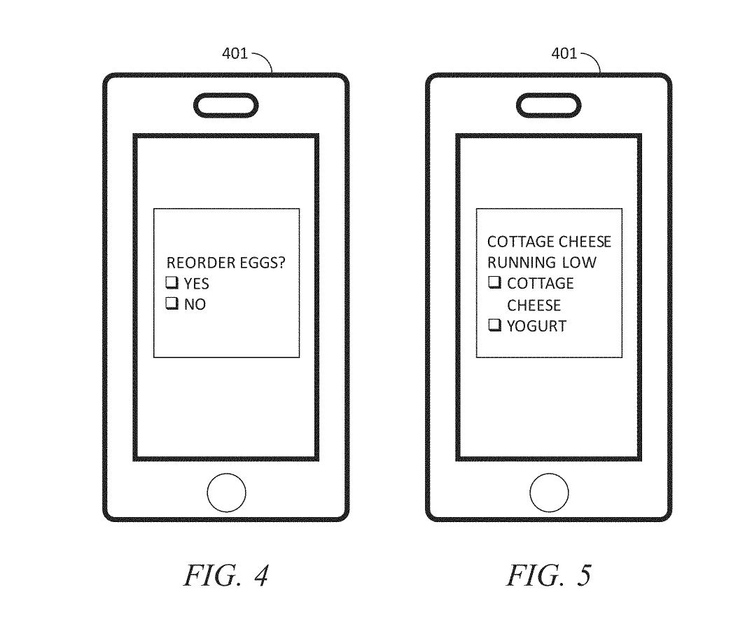

By another approach, the set of rules may provide for automatically initiating the replacement of the consumable item within the storage area 101 by automatically notifying the end-user consumer regarding an opportunity to replace the consumable item. By one approach the set of rules may generally provide for automatic replacement but may permit the end-user to specify a user-permission requirement for specific consumable items. FIG. 4 presents a simple illustrative example in these regards where the consumable item eggs are subject to such a constraint. In this example the control circuit 102 sends an in-app alert to the end user's smart phone 401. This alert identifies the consumable item (in this case, eggs) and provides the end user with an opportunity to authorize reordering by clicking a “yes” response or to do the opposite by clicking a “no” response.

By yet another approach, the set of rules may provide for automatically notifying the end-user consumer regarding an opportunity to replace the consumable item by presenting the end-user consumer with at least one item that is an alternative to the consumable item. FIG. 5 presents a simple illustrative example in these regards where the consumable item cottage cheese is running low and the control circuit 102 sends an in-app alert to the end user's smart phone 401 to indicate that circumstance and to provide the end user with an opportunity to reorder cottage cheese or, as an alternative, yogurt.

So configured, a variety of stored consumable items can be readily monitored and replenished in a manner that greatly reduces the likelihood that the end-user consumer will be without such items. Those skilled in the art will appreciate that these teachings are readily applied with respect to a wide variety of existing items and existing packaging without requiring modification thereof. It will also be appreciated that these teachings will accommodate considerable end-user customization to best suit individual preferences and circumstances. Although the rules employed to achieve these results are different than ordinary replenishment rules that end-users might typically employ when undertaking such activities on their own behalf, it will be appreciated that these rules nevertheless achieve useful, timely, efficient, reliable, and reproducible results.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus to support storage and automatic replacement of a consumable item in an end user consumer's application setting, the apparatus comprising:
at least one non-weight-based sensor configured to be physically deployed within a storage area and to sense a not-fully-depleted consumption state of the consumable item within the end user consumer's application setting;
a control circuit operably coupled to the non-weight-based sensor and configured to respond to detection of a particular not-fully-depleted consumption state of the consumable item by automatically initiating replacement of the consumable item within the storage area.

2. The apparatus of claim 1 wherein the storage area comprises at least one of a residential refrigerator and a residential freezer.

3. The apparatus of claim 1 wherein the storage area comprises at least one of a residential pantry and a residential closet.

4. The apparatus of claim 1 wherein the storage area comprises at least one of a residential cupboard, a residential cabinet, and a residential shelf.

5. The apparatus of claim 1 wherein the non-weight-based sensor comprises an image-based sensor.

6. The apparatus of claim 1 wherein the non-weight-based sensor comprises an ultrasonic-based sensor.

7. The apparatus of claim 1 wherein the not-fully-depleted consumption state of the consumable item comprises a consumption state between seventy percent depleted and ninety percent depleted.

8. The apparatus of claim 1 wherein the control circuit is configured to automatically initiate the replacement of the consumable item within the storage area by automatically ordering at least one new one of the consumable item.

9. The apparatus of claim 1 wherein the control circuit is configured to automatically initiate the replacement of the consumable item within the storage area by automatically ordering an item that is an alternative to the consumable item.

10. The apparatus of claim 1 wherein the control circuit is configured to automatically initiate the replacement of the consumable item within the storage area by automatically notifying the end-user consumer regarding an opportunity to replace the consumable item.

11. The apparatus of claim 1 wherein the control circuit is configured to automatically notify the end-user consumer regarding the opportunity to replace the consumable item by providing the end-user consumer with an opportunity to permit or not permit replacement of the consumable item.

12. The apparatus of claim 1 wherein the control circuit is configured to automatically notify the end-user consumer regarding an opportunity to replace the consumable item by presenting the end-user consumer with at least one item that is an alternative to the consumable item.

13. A method to support storage and automatic replacement of a consumable item in an end user consumer's application setting, the method comprising:
providing at least one non-weight-based sensor within a storage area to sense a not-fully-depleted consumption state of the consumable item within the end user consumer's application setting;
by a control circuit that is operably coupled to the non-weight-based sensor:
detecting via the non-weight-based sensor a particular not-fully-depleted consumption state of the consumable item;
in response to detecting the particular not-fully-depleted consumption state of the consumable item:
accessing a set of rules that define re-ordering activities as a function of the not-fully-depleted consumption state of a consumable item;
using the set of rules to automatically initiate replacement of the consumable item within the storage area.

14. The method of claim 13 wherein the non-weight-based sensor comprises at least one of an image-based sensor and an ultrasonic-based sensor.

15. The method of claim 13 wherein the not-fully-depleted consumption state of the consumable item comprises a consumption state between seventy percent depleted and ninety percent depleted.

16. The method of claim 13 wherein the set of rules provide for automatically initiating the replacement of the consumable item within the storage area by automatically ordering at least one new one of the consumable item.

17. The method of claim 13 wherein the set of rules provide for automatically initiating the replacement of the consumable item within the storage area by automatically ordering an item that is an alternative to the consumable item.

18. The method of claim 13 wherein the set of rules provide for automatically initiating the replacement of the consumable item within the storage area by automatically notifying the end-user consumer regarding an opportunity to replace the consumable item.

19. The method of claim 13 wherein the set of rules provide for automatically notifying the end-user consumer regarding the opportunity to replace the consumable item by providing the end-user consumer with an opportunity to permit or not permit replacement of the consumable item.

20. The method of claim 13 wherein the set of rules provide for automatically notifying the end-user consumer regarding an opportunity to replace the consumable item by presenting the end-user consumer with at least one item that is an alternative to the consumable item.
